(19) United States
(12) Patent Application Publication
(10) Pub. No.: US 2002/0076466 A1
(43) Pub. Date: Jun. 20, 2002

(54) Sequential mold lifter

(76) Inventors: Timothy A. Mowery, West Olive, MI (US); Mark S. Clark, Howard City, MI (US)

Correspondence Address: Waters & Morse, P.C., 400 Ledyard Building, 125 Ottawa, Avenue, NW, Grand Rapids, MI, 49503, US

(21) Appl. No.: 09/970,737

(22) Filed: Oct. 3, 2001

Related U.S. Application Data
(60) Provisional application No. 60/237,609, filed on Oct. 3, 2000.

(51) Int. Cl. B29C 45/44

(52) U.S. Cl. 425/556; 425/577; 425/438; 425/441; 425/DIG. 58

(57) ABSTRACT

A sequential mold lifter for a molded part forming device comprises at least first, second and third lifter segments that slidably engage one another. The first and third lifter sections are positioned on opposite sides of the second section and slide upwardly and inwardly on inclined lifter surfaces on the second lifter section. Separate actuators extend all of the lifter sections to a first extended position and then extend the first and third actuators upwardly and inwardly beyond the second actuator to a second extended position. The relative movement of the lifter sections dislodges the molded product from the mold and then dislodges the product from the lifter. The inclination of the actuators can vary with the positions of the lifter sections. Movable slides support the actuators but permit variation in the inclination of the actuators.

### CROSS-REFERENCES TO RELATED APPLICATIONS

This application is based on and claims the benefit of the filing date of co-pending U.S. Provisional Patent Application Serial No. 60/237,609, entitled Sequential Mold Lifter and filed on Oct. 3, 2000, by Timothy A. Mowery and Mark S. Clark, the disclosure of which is incorporated here by reference.

### STATEMENT REGARDING FEDERALLY SPONSORED RESEARCH OR DEVELOPMENT

Not Applicable.

### BACKGROUND OF THE INVENTION

The invention relates to molded part forming devices and in particular to a mold that has two portions that align with and abut one another in a closed position, defining a mold cavity between the two portions in the closed position, and the two portions being separated from one another in an open position. The mold further having a lifter that seats into the mold cavity and abuts at least one of the two mold portions in the closed position.

### BRIEF SUMMARY OF THE INVENTION

In accordance with the present invention, a sequential mold lifter for a molded part forming device, such as an injection molding machine, which has cooperating first and second mold portions that open and close, comprises a multipart lifter that moves in such a way that a molded part that envelops the lifter is automatically removed from the mold and the mold lifter. The sequential mold lifter comprises at least first and second lifter segments and preferably at a third lifter section as well. The lifter segments slidably engage one another. In one aspect of the invention, the first and third lifter sections are positioned on opposite sides of the second section and slide upwardly and inwardly on inclined lifter surfaces on the second lifter section. A first actuator extends and retracts the first lifter segment relative to one of the first and the second mold portions. A second actuator extends and retracts the second lifter segment relative to the same one of the first and the second mold portions. A third actuator extends and retracts the third lifter. Preferably the first and third actuators are inclined at substantially the same angle as the lifter surfaces between the lifter sections. The actuators extend all of the lifter sections simultaneously to a first extended position and further extend the first and third actuators beyond the second actuator to a second extended position. The relative movement of the lifter sections dislodges the molded product from the mold and then dislodges the product from the lifter. The inclination of the actuators can vary with the positions of the lifter sections. Movable slides support the actuators but permit variation in the inclination of the actuators.

These and other feature, objects, and benefits of the invention will be recognized by one having ordinary skill in the art and by those who practice the invention, from the specification, the claims, and the drawing figures.

### BRIEF DESCRIPTION OF THE SEVERAL VIEWS OF THE DRAWING

FIG. 1 is a fragmentary longitudinal cross-sectional view of a mold that incorporates a sequential mold lifter of the invention, showing the mold and the sequential mold lifter in a closed condition;

FIG. 2 is the view of FIG. 1, showing a top of the mold removed and the sequential mold lifter in a partially lifted position;

FIG. 3 is the view of FIG. 2, showing the sequential mold lifter in a fully lifted position;

FIG. 4 is a fragmentary transverse cross-sectional view along line IV-IV of FIG. 1; and

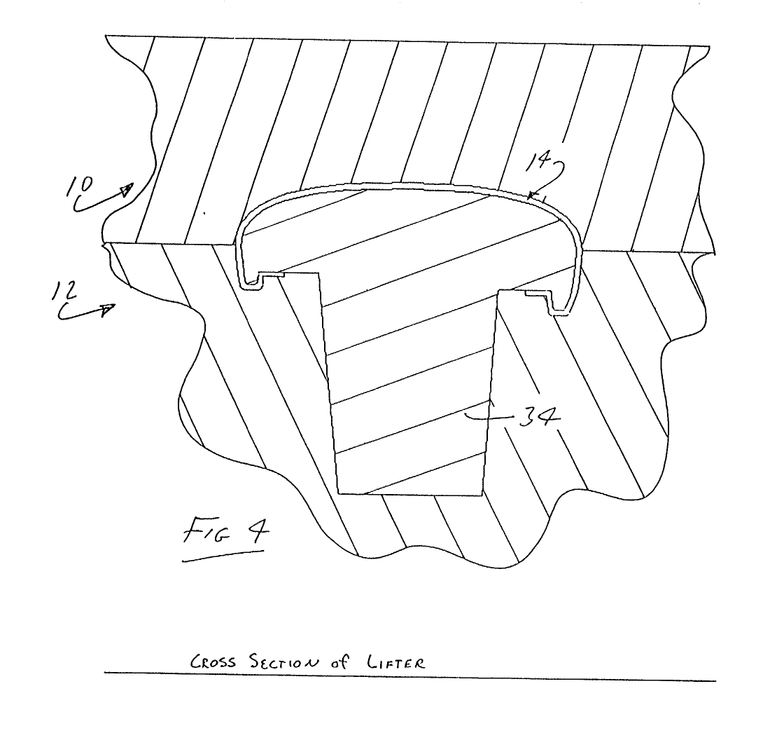

FIG. 5 is a fragmentary plan view of an interface between two segments of the sequential mold lifter as indicated by sight line V-V of FIG. 1.

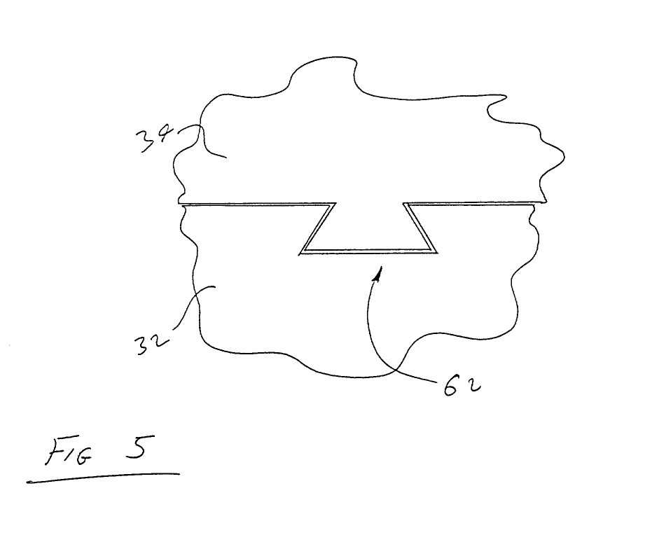

### DETAILED DESCRIPTION OF THE INVENTION

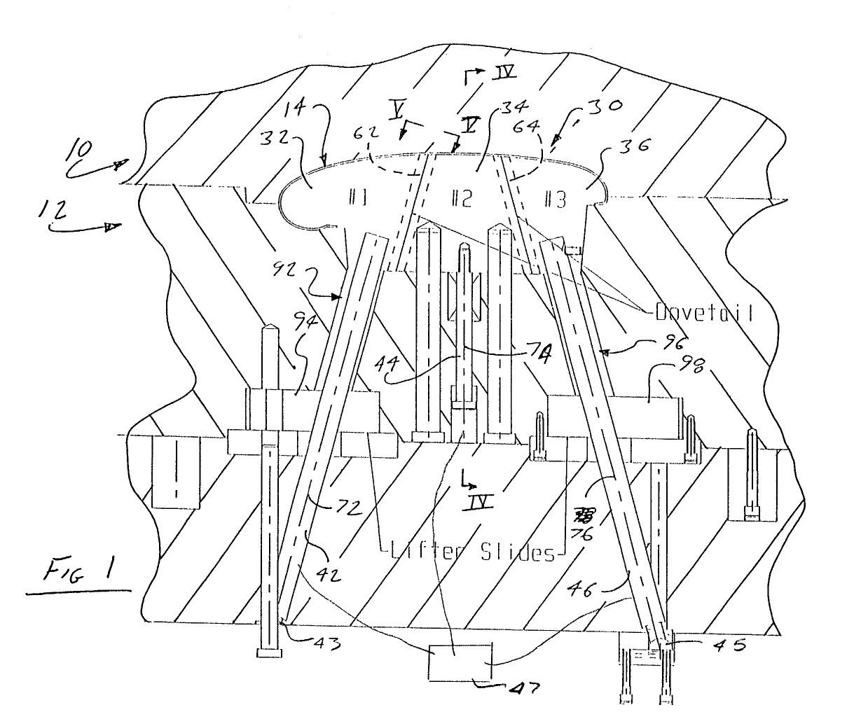

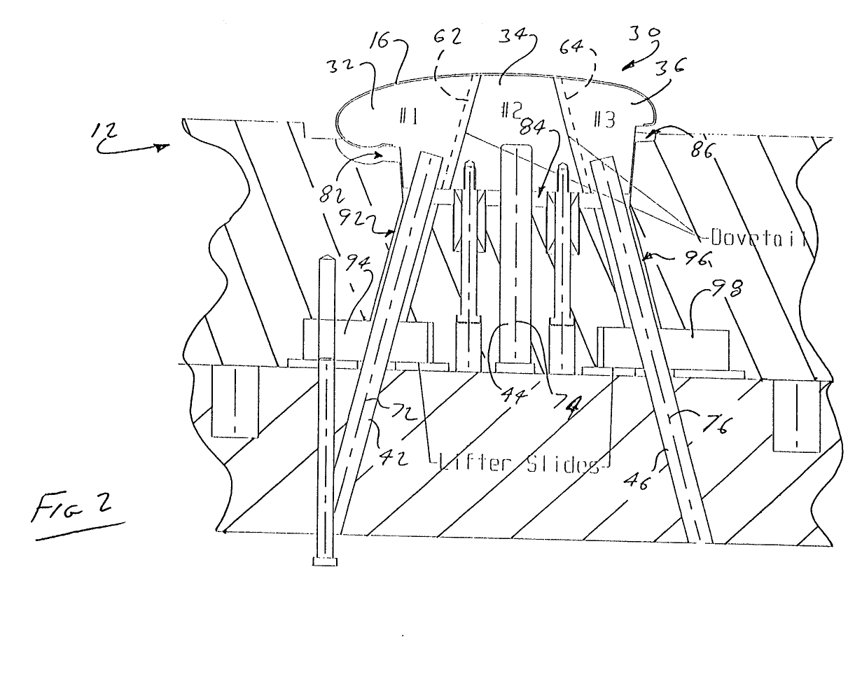

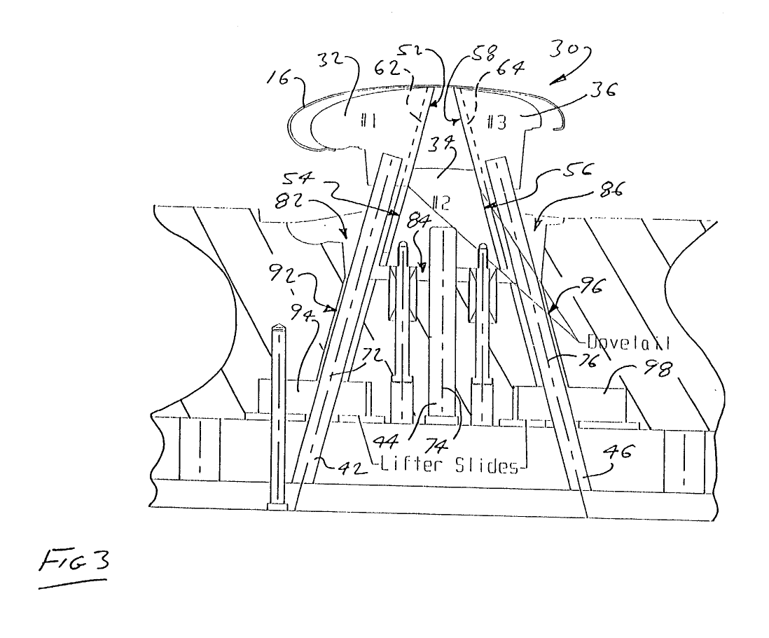

A preferred embodiment of a sequential mold lifter according to the invention is generally shown in the drawing figures. As shown, the sequential mold lifter is useful in a molded part forming device that has a first mold portion 10 and a cooperating second mold portion 12 (FIG. 1). As will be understood by one having ordinary skill in the art, a device that forms molded parts commonly includes the first and the second mold portions 10 and 12, respectively, which align with and abut one another in a closed position and define a mold cavity 14 in which a molded part 16 maybe formed. Further, the first and the second mold portions 10 and 12, respectively, separate from one another in an open position (FIGS. 2 and 3) as will be understood by one having ordinary skill in the art.

The sequential mold lifter as shown includes a lifter 30 that is sectioned into first, second and third lifter sections 32, 34, and 36, respectively. Each of the three lifter sections 32, 34, and 36, respectively, is connected with the second mold portion 12 by an actuator 42, 44, and 46, respectively. A drive mechanism 47 (shown schematically) controls the actuation of the actuators. This can be conventional.

Each of the three lifter sections 32, 34, and 36, respectively, may be constructed of any suitable structural material as will be understood by one having ordinary skill in the art. The first lifter section 32 has a generally planar first lifter surface 52, while the second lifter section 34 has opposing generally planar second and third lifter surfaces 54 and 56, respectively, and the third lifter section 36 has a generally planar fourth lifter surface 58 (FIG. 3). The first lifter section 32 and the second lifter section 34 are oriented relative to one another with the first lifter surface 52 and the second lifter surface 54 in abutting engagement. Likewise, the second lifter section 34 and the third lifter section 36 are oriented relative to one another with the third lifter surface 56 and the fourth lifter surface 58 in abutting engagement.

A connector 62 slidably interconnects the first and the second lifter segments 32 and 34, respectively, and maintains the relative positioning of the first and the second lifter segments and the first and second lifter surface 52 and 54, respectively. While various connectors may be used, the inventors have found that a dovetail joint between the first and the second lifter segments 32 and 34, respectively, is effective without being unduly complicated. Likewise, a connector 64 slidably interconnects the second and the third lifter segments 34 and 36, respectively, and maintains the relative positioning of the second and the third lifter segments and the third and fourth lifter surface 56 and 58, respectively.

Each of the actuators, 42, 44, and 46, respectively, may be any of various actuators that are or may be known to one having ordinary skill in the art. The actuator 42 has a line or axis of action 72, while the actuator 44 has a line or axis of action 74 and the actuator 46 has a line or axis of action 76.

The second actuator 44 connects between the second lifter section 34 and a second cavity segment 84. The second actuator 44 slides between a retracted position (FIG. 1) and a first extended position (FIG. 2). The second lifter section 34 seats into the mold cavity and abuts at least some of the second cavity segment 84 in the retracted position. Further, the second lifter section 34 is at least partially spaced apart from the second cavity segment 84 in the first extended position.

The first actuator 42 connects between the first lifter section 32 and a first cavity segment 82 while the third actuator 46 connects between the third lifter section 36 and a third cavity segment 86. As with the second actuator 44 and the second lifter section 34, just discussed above, the first and third actuators 42 and 46, respectively, also slide between the retracted position (FIG. 1) and the first extended position (FIG. 2). The first lifter section 32 seats into the mold cavity and abuts at least some of the first cavity segment 82 in the retracted position while the third lifter section 36 seats into the mold cavity and abuts at least some of the third cavity segment 86 in the retracted position. Further, the first lifter section 32 is at least partially spaced apart from the first cavity segment 82 in the first extended position while the third lifter section 36 is at least partially spaced apart from the third cavity segment 86 in the first extended position.

Unlike the second actuator 44 and the second lifter section 34, however, the first and third actuators 42 and 46, respectively, further extend through the first extended position to a second extended position (FIG. 3) in which the first and third lifter sections 32 and 36, respectively, are further spaced apart from the first and third cavity segments 82 and 86, respectively. This then means that the first and third lifter sections 32 and 36 are also extended beyond the second lifter section 34.

Moving the lifter 30, which has the lifter sections 32, 34, and 36, for the retracted position in the second mold portion 12 (FIG. 1) to the first extended position (FIG. 2) facilitates removal of the molded part 16, especially in the case of when at least a portion of the molded part wraps around the lifter. Now, the further extension of the first and third lifter sections, 32 and 36, respectively, past the second lifter section 34 to the second extended position (FIG. 3) actually removes the molded part 16 from the second lifter section 34. It should be noted that the molded part 16 is a flexible resilient member that can deform around the lifter 30 and its sections 32, 34, and 36 and recover its original molded configuration without damage.

To minimize potential damage to the molded part 16, however, when the first and third lifter sections, 32 and 36, respectively, move to the second extended position (FIG. 3), the first and third lifter sections most preferably also move toward each other when further extending from the first extended position to the second extended position. This may be accomplished in the preferred embodiment by defining a first reference plane that coincides with an interface between the first lifter surface 52 and the second lifter surface 54 and further orienting the first reference plane parallel with the axis 72. The axis 72 is in the illustrated embodiment preferably inclined at an included angle of about 15 degrees relative to the axis 74. Likewise, a second reference plane that coincides with an interface between the third lifter surface 56 and the fourth lifter surface 58 is oriented parallel with the axis 76. The axis 76 is preferably similarly inclined at an included angle of about 15 degrees relative to the axis 74, which of course defines an angle of about 30 degrees between the axis 72 and the axis 76.

With the first and the second reference planes so defined, the first lifter section 32 and the third lifter section 36 will cam or slide along the second lifter second 34, closing toward one another, as the first lifter section and the third lifter section progress from the first extended position (FIG. 2) to the second extended position (FIG. 3). In the second extended position, the first lifter section 32 and the third lifter section 36 will be closer to one another than in either of the retracted position (FIG. 1) or the first extended position (FIG. 2). Thus, the molded part 16 will inherently peel or separate from the first lifter section 32 and the third lifter section 36 as the first lifter section and the third lifter section move toward one another and to the second extended position.

Because the first and the third lifter sections 32 and 36, respectively, cam or slide along the second lifter second 34, closing toward one another, as the first and the third lifter sections progress from the first extended position to the second extended position, each of the first and the third actuators 42 and 46, respectively, must be provided a tolerance of movement with the first and the third lifter sections. Conversely, the first and the third lifter sections 32 and 36, respectively, cam along the second lifter second 34, separating from one another, as the first and the third lifter sections progress from the second extended position and through the first extended position to the retracted position. Thus, each of the first actuator 42 and the third actuator 46 is movably mounted in the second or lower mold portion 12. This can be accomplished by pivot joints 43 and 45 at inner or lower ends of the actuators.

More particularly, movement of the first and the third actuators 42 and 46, respectively, is accommodated with associated slides and passages. The first actuator 42 extends from the first lifter section 32 and through an actuator passage 92 to a slide 94. Likewise, the third actuator 46 extends from the third lifter section 36 and through an actuator passage 96 to a slide 98. Each of the actuator passage 92 and the actuator passage 96 is a generally cylindrical passage that has an elongated or oval cross section. Thus, movement of the first and the third actuators 42 and 46, respectively, toward and away from one another when they extend and retract is provided, as will be understood by one having ordinary skill in the art.

It will further be understood by one having ordinary skill in the art and by those who practice the invention, that various modifications and improvements may be made without departing from the spirit of the disclosed concept. Various relational terms, including left, right, front, back, top, and bottom, for example, are used in the detailed description of the invention and in the claims only to convey relative positioning of various elements of the claimed invention. The scope of protection afforded is to be determined by the claims and by the breadth of interpretation allowed by law.

I claim:

1. In a molded part forming device that has a first mold portion and a cooperating second mold portion, the first and the second mold portions aligning with and abutting one another in a closed position, the first and the second mold portions defining a mold cavity between the first and the second mold portions in the closed position, and the first and the second mold portions being separated from one another in an open position, the improvement of a sequential lifter comprising:
first and third laterally spaced lifter sections corresponding respectively to first and third cavity segments of the mold cavity, the first and third lifter sections having opposed upwardly and inwardly inclined first and third lifter surfaces;
first and third actuators connected at upwardly and inwardly inclined angles between the first and third lifter sections and the first and third cavity segments, respectively, the first and third actuators each being extendible to move the first and third lifter sections from a retracted position to a first extended position, and then to a second extended position, the first and third lifter sections seating into the mold cavity and substantially abutting at least some of the first and third cavity segments in their retracted positions, the first and third lifter sections being at least partially spaced apart from the first and third cavity segments in their first extended positions,
a second lifter segment corresponding to a second cavity segment of the mold cavity, the second lifter segment being positioned between the first and third lifter segments and having second upwardly and inwardly inclined lifter surfaces that abut the first and third lifter surfaces in sliding engagement;
a second actuator connected between the second lifter segment and the second cavity segment, the second actuator being extendible from a retracted position to a first extended position, the second lifter section seating into the mold cavity in the retracted position, the second lifter section being at least partially spaced apart from the second cavity segment in the first extended position, the second lifter section thereafter remaining at the first elevated position while the first and third lifter sections slide upwardly and inwardly on the second lifter surfaces from the first extended position to the second extended position; and
drive means for extending all actuators simultaneously to the first extended position and then extending the first and third actuators further beyond the first extended position to a second extended position, the lifter thus first separating from the mold and then the first and third lifter sections moving inwardly toward each other to separate the molded part from outer edges of the first and third lift sections.

2. A molded part forming device as in claim 1 and further comprising a connector that slidably interconnects the first and third lifter surfaces with the second lifter surfaces and constrains the segments to longitudinal sliding motion along the lifter surfaces.

3. A molded part forming device as in claim 2 wherein the connector is a dovetail slot connector.

4. A molded part forming device as in claim 1 wherein the lifter segments move substantially together in moving from the retracted to the first extended positions, and then the first and third lifter segments move outwardly from the second lifter segment while moving inwardly toward each other, causing separation of the molded part from the lifter.

5. A molded part forming device as in claim 4, wherein the first and third actuators are generally aligned with the inclined first and third lifter surfaces, respectively, at least when the lifter segments are in their first extended position.

6. A molded part forming device as in claim 1 wherein the first and third actuators are pivotally mounted so as to permit variation in the angle of inclination of the first and third actuators as the first and third lifter segments are moved between their retracted, first extended, and second extended positions.

7. A molded part forming device as in claim 6 wherein the first and third actuators are elongated members mounted to the lifter segments at an outer end and to the mold portions at an inner end, intermediate portions of the actuators being mounted in lifter slides that support the actuators but are slidable to permit variation in the angle of inclination of the actuators.

8. A molded part forming device as in claim 7 wherein the first and third actuators extend through elongated openings in the mold portions, the openings being sufficiently larger than the actuators to permit necessary variation in inclination of the actuators between their retracted, first extended, and second extended positions.

9. A molded part device as in claim 8 wherein the openings have a non-circular cross-section, with a major axis extending in the direction of variation of the angle of inclination of the actuators.
